(19) United States
(12) Patent Application Publication
(10) Pub. No.: US 2010/0032885 A1
(43) Pub. Date: Feb. 11, 2010

(54) Bidirectional-to-unidirectional transmission system and sheet feeding apparatus using the same

(76) Inventor: Aihua XU, Jiangsu Province (CN)

Correspondence Address: Muncy, Geissler, Olds & Lowe, PLLC, P.O. BOX 1364, FAIRFAX, VA, 22038-1364, US

(21) Appl. No.: 12/483,804

(22) Filed: Jun. 12, 2009

(30) Foreign Application Priority Data
Aug. 5, 2008 (TW) 097129598

(51) Int. Cl. F16H 37/06; B65H 5/06

(52) U.S. Cl. 271/8.1; 74/665 F

(57) ABSTRACT

A transmission system includes a rotatable main gear, first and second transmission gears rotatably and movably disposed and respectively in constant mesh with the main gear, and first and second power output components rotatably disposed and in constant mesh with each other. The first and second transmission gears detachably mesh with the first and second power output components respectively. The main gear is rotated counterclockwise to drive the second transmission gear away from the second power output component, and to drive the first transmission gear to mesh with the first power output component to rotate the first and second power output components. The main gear is rotated clockwise to drive the first transmission gear away from the first power output component, and to drive the second transmission gear to mesh with the second power output component to rotate the second and first power output components.

This application claims priority of No. 097129598 filed in Taiwan R.O.C. on Aug. 5, 2008 under 35 USC 119, the entire content of which is hereby incorporated by reference.

### BACKGROUND OF THE INVENTION

1. Field of the Invention

The invention relates to a motive power transmission system which transmits a bidirectional power input to a unidirectional power output, and a sheet feeding apparatus using the same.

2. Related Art

An automatic document feeder can be applied to a document image processing apparatus, such as a scanner, a printer, a copier or a multi-function peripheral. In order to achieve duplex image processing using a single image processing module, the automatic document feeder has to transport a sheet past an image processing region twice or thrice. In the scanner, for example, the automatic document feeder typically transports an original past a scan region thrice so that a scanning module of the scanner can acquire a front-side image and a back-side image of the original.

In order to shorten overall scan time, the automatic document feeder needs to feed a successive original from a supply tray while the preceding original is under processing in a sheet passageway. In this case, some feeding rollers for transporting originals have to reverse their rotational directions so that the preceding original can be turned over, whereas other feeding rollers are rotated in a constant direction to transport the successive original to the scan region.

To satisfy this requirement, conventionally, two sets of motors and control circuits are adopted to respectively drive the feeding rollers rotating in a constant direction and the feeding rollers rotating in forward and reverse directions. However, the cost of the document image processing apparatus is thus increased due to the additional motor and control circuit.

Therefore, it is an important subject of the invention to provide a transmission system which can convert power inputs in both rotational directions into a power output in one rotational direction, and a sheet feeding apparatus using the same.

### SUMMARY OF THE INVENTION

It is therefore an object of the invention to provide a bidirectional-to-unidirectional transmission system, and a sheet feeding apparatus using the same. The transmission system can output a unidirectional motive power without respect to the directions of inputted motive power, so that the rollers driven by the transmission system may be rotating in a constant direction while the power source driving the transmission system inputs power in varied rotational directions, and thus only a single power source will be sufficient for the driving of all the rollers in the sheet feeding apparatus.

To achieve the above-identified object, the invention provides a transmission system including a main gear, a first transmission gear, a second transmission gear, a first power output component and a second power output component. The main gear is rotatably disposed. The first transmission gear and the second transmission gear are rotatably and movably disposed and are respectively in constant mesh with the main gear. The first power output component and the second power output component are rotatably disposed and in constant mesh with each other. The first transmission gear detachably meshes with the first power output component, and the second transmission gear detachably meshes with the second power output component. The main gear is rotated counterclockwise to drive the second transmission gear away from the second power output component, and to drive the first transmission gear to mesh with the first power output component to rotate the first power output component and the second power output component. The main gear is rotated clockwise to drive the first transmission gear away from the first power output component, and to drive the second transmission gear to mesh with the second power output component to rotate the second power output component and the first power output component.

The invention also provides a sheet feeding apparatus including a first passageway, a second passageway, a third passageway, a unidirectional rotation roller, a bidirectional rotation roller and a transmission system. The third passageway is connected to the first passageway and the second passageway. The unidirectional rotation roller rotates in a first direction to transport a sheet into the first passageway and the second passageway. The bidirectional rotation roller rotates in the first direction to transport the sheet out of the second passageway, and rotates in a second direction reverse to the first direction to transport the sheet from the second passageway to the third passageway and the first passageway. The transmission system drives the unidirectional rotation roller and the bidirectional rotation roller. The transmission system comprises a main gear, a first transmission gear, a second transmission gear, a first power output component and a second power output component. The main gear is rotatably disposed and the bidirectional rotation roller is driven by the main gear to rotate in one of the first direction and the second direction. The first transmission gear and the second transmission gear are rotatably and movably disposed and are respectively in constant mesh with the main gear. The first power output component and the second power output component are rotatably disposed and in constant mesh with each other. The first transmission gear detachably meshes with the first power output component, and the second transmission gear detachably meshes with the second power output component. The unidirectional rotation roller is driven by one of the first power output component and the second power output component to rotate in the first direction. The main gear is rotated counterclockwise to drive the second transmission gear away from the second power output component, and to drive the first transmission gear to mesh with the first power output component to rotate the first power output component and the second power output component. The main gear is rotated clockwise to drive the first transmission gear away from the first power output component, and to drive the second transmission gear to mesh with the second power output component to rotate the second power output component and the first power output component.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1 is a schematic illustration showing a sheet feeding apparatus according to a first embodiment of the invention.

FIG. 2 is a schematic illustration showing a first state of a transmission system according to the first embodiment of the invention.

FIG. 3 is a schematic illustration showing a second state of the transmission system according to the first embodiment of the invention.

FIG. 4 is a schematic illustration showing a first state of a transmission system according to a second embodiment of the invention.

FIG. 5 is a schematic illustration showing a second state of the transmission system according to the second embodiment of the invention.

### DETAILED DESCRIPTION OF THE INVENTION

The present invention will be apparent from the following detailed description, which proceeds with reference to the accompanying drawings, wherein the same references relate to the same elements.

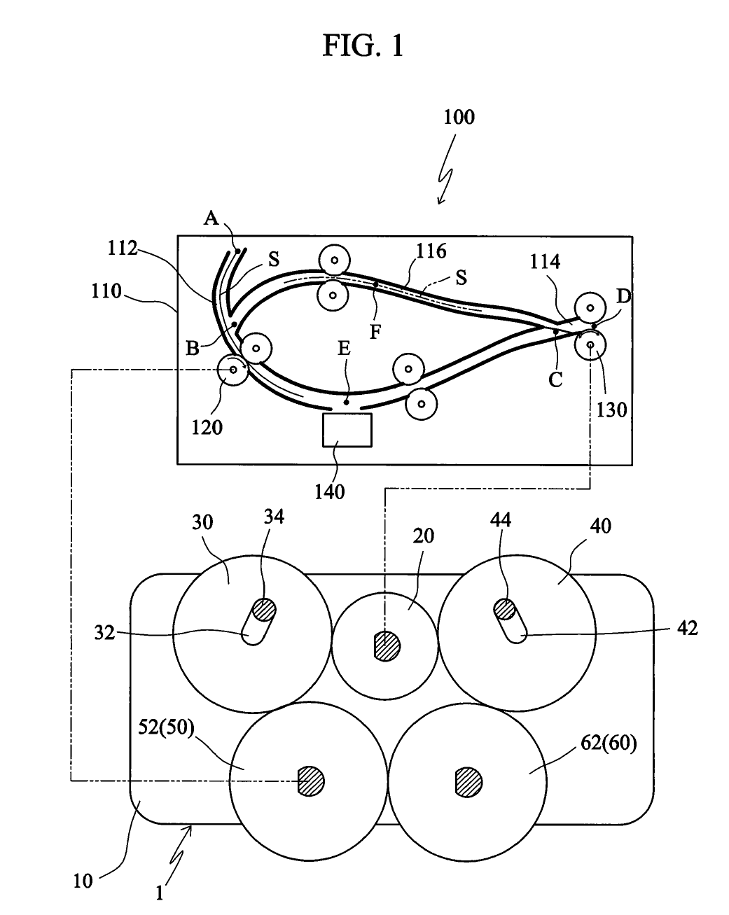

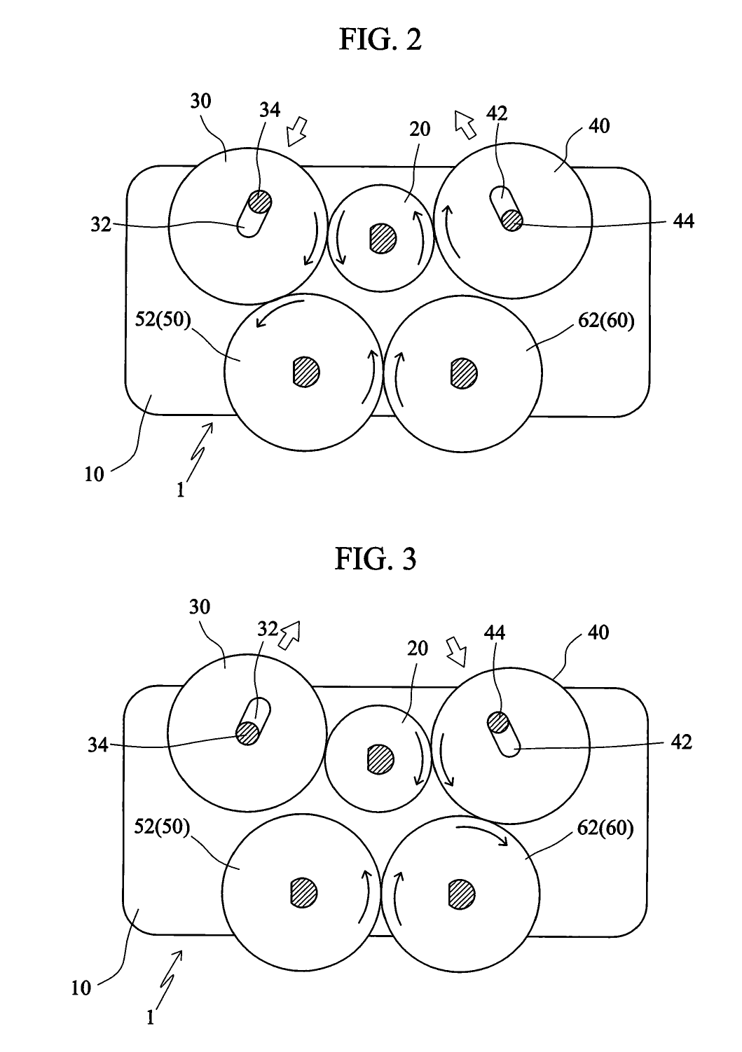

FIG. 1 is a schematic illustration showing a sheet feeding apparatus 100 according to a first embodiment of the invention. FIGS. 2 and 3 are schematic illustrations respectively showing a first state and a second state of a transmission system of the sheet feeding apparatus 100 according to the first embodiment of the invention. Referring to FIG. 1, the sheet feeding apparatus 100 of this embodiment includes a housing 110, a unidirectional rotation roller 120, a bidirectional rotation roller 130 and a transmission system 1.

The sheet feeding apparatus 100 may be applied to a document image processing apparatus, such as a scanner, a printer, a copier or a multi-function peripheral. In this embodiment, the scanner is used as an example. The housing 110 is formed with a sheet passageway, which includes a first passageway 112, a second passageway 114 and a third passageway 116 connected to the first passageway 112 and the second passageway 114. The range of the first passageway 112 is designated by points A, B, E and C, the range of the second passageway 114 is designated by points C and D, and the range of the third passageway 116 is designated by points C, F and B.

The unidirectional rotation roller 120 is installed in the housing 110 and rotates in a first direction to transport a sheet S into the first passageway 112 and the second passageway 114.

The bidirectional rotation roller 130 is installed in the housing 110 and rotates in the first direction to transport the sheet S out of the second passageway 114. In addition, the bidirectional rotation roller 130 further rotates in a second direction reverse to the first direction to transport the sheet S from the second passageway 114 to the third passageway 116 and then to the first passageway 112.

The sheet feeding apparatus 100 may further include a scanning module 140 disposed in the housing 110. The scanning module 140 is located at the point E of the first passageway 112 and acquires images of the sheet S transported through the first passageway 112. When the scanner is set to scan both sides of the sheet S, the unidirectional rotation roller 120 and the bidirectional rotation roller 130 are rotated clockwise to transport the sheet S past the points A, B, E, C and D in order. At this time, the scanning module 140 acquires an image of the first side of the sheet S. Then, the bidirectional rotation roller 130 is rotated counterclockwise to transport the sheet S into the third passageway 116 and past the points F and B in order. Next, the bidirectional rotation roller 130 and the unidirectional rotation roller 120 are rotated clockwise to transport the sheet S into the first passageway 112 and past the points B, E, C and D in order. At this time, the scanning module 140 acquires an image of the second side of the sheet S at the point E. Then, the bidirectional rotation roller 130 is rotated counterclockwise to transport the sheet S into the third passageway 116 and past the points F and B in order. Finally, the unidirectional rotation roller 120 and the bidirectional rotation roller 130 are rotated clockwise to transport the sheet S into the first passageway 112 and past the points B, E, C and D in order, and to transport the sheet S from the second passageway 114 to a discharge tray. When the sheet S is transported past the point E of the first passageway 112 at the last time, the scanning module 140 does not acquire an image of the sheet S. The object of this process is to keep the order of a stack of sheets unchanged. In the scanning procedure mentioned above, the unidirectional rotation roller 120 is always rotated clockwise, and the bidirectional rotation roller 130 is rotated clockwise and counterclockwise alternately.

The transmission system 1 drives the unidirectional rotation roller 120 and the bidirectional rotation roller 130. The transmission system 1 includes a main gear 20, a first transmission gear 30, a second transmission gear 40, a first power output component 50 and a second power output component 60.

The main gear 20 is rotatably mounted on, for example, a frame 10. The frame 10 may be disposed on the housing 110, or may be one portion of the housing 110. The main gear 20 changes its rotational direction with respect to the change of the rotational direction of a power input by a motor. The bidirectional rotation roller 130 is driven by the main gear 20 to rotate in the first direction and the second direction alternately.

The first transmission gear 30 and the second transmission gear 40 are rotatably and movably mounted on, for example, the frame 10. The first transmission gear 30 and the second transmission gear 40 are respectively in constant mesh with the main gear 20.

The first power output component 50 and the second power output component 60 are rotatably disposed on, for example, the frame 10. The first power output component 50 and the second power output component 60 are in constant mesh with each other. The first transmission gear 30 detachably meshes with the first power output component 50. The second transmission gear 40 detachably meshes with the second power output component 60. That is, since the first transmission gear 30 and the second transmission gear 40 are movable, the first transmission gear 30 and the second transmission gear 40 are driven to engage or detach from the first power output component 50 and the second power output component 60 respectively. The unidirectional rotation roller 120 is driven by one of the first power output component 50 and the second power output component 60 to rotate in the first direction.

In this embodiment, the first power output component 50 is a third transmission gear 52, and the second power output component 60 is a fourth transmission gear 62. Thus, the unidirectional rotation roller 120 is driven by one of the third transmission gear 52 and the fourth transmission gear 62 to rotate in the first direction.

The transmission system 1 has two states. In the first state, as shown in FIG. 2, the main gear 20 is rotated counterclockwise to drive the second transmission gear 40 away from the second power output component 60. Simultaneously, the main gear 20 also drives the first transmission gear 30 to mesh with the first power output component 50 to rotate the first power output component 50 and the second power output component 60.

In the second state, as shown in FIG. 3, the main gear 20 is rotated clockwise to drive the first transmission gear 30 away from the first power output component 50. The main gear 20 simultaneously drives the second transmission gear 40 to mesh with the second power output component 60 to rotate the second power output component 60 and the first power output component 50.

Therefore, the third transmission gear 52 is driven to rotate counterclockwise, and the fourth transmission gear 62 is driven to rotate clockwise perpetually despite the rotational direction of the main gear 20.

In order to make the first transmission gear 30 and the second transmission gear 40 be moveable and rotatable, the first transmission gear 30 and the second transmission gear 40 respectively are provided with a first gear bore 32 and a second gear bore 42, and are respectively rotatably and movably mounted on a first pin 34 and a second pin 44 which are received by the first gear bore 32 and the second gear bore 42 respectively. The first transmission gear 30 and the second transmission gear 40 are respectively moveable in extending directions of the first gear bore 32 and the second gear bore 42, as indicated by the hollow arrows in FIGS. 2 and 3.

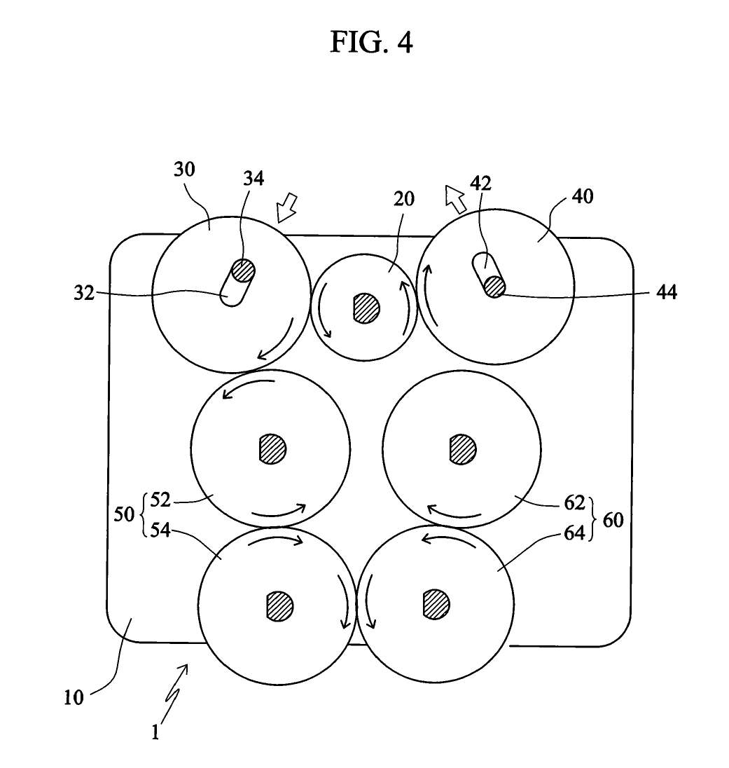

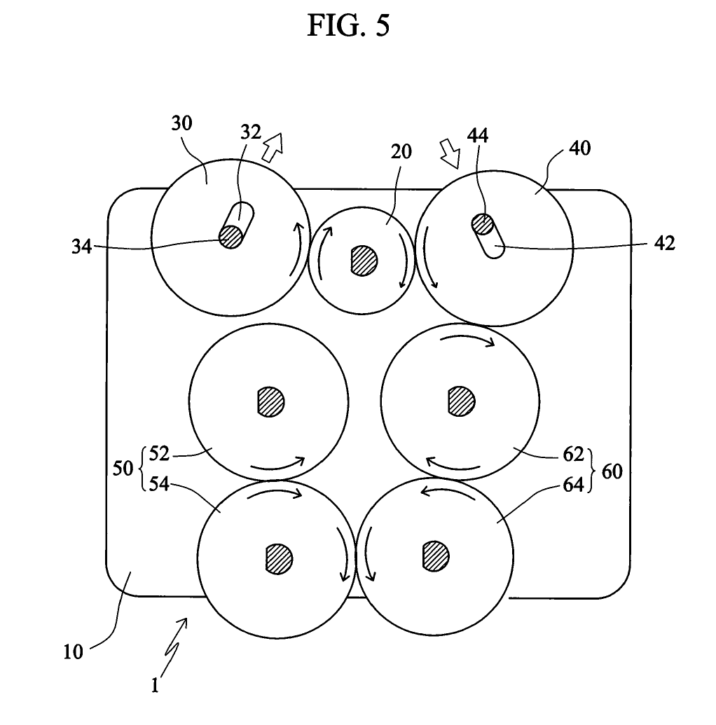

FIGS. 4 and 5 are schematic illustrations showing a first state and a second state of a transmission system according to a second embodiment of the invention. As shown in FIGS. 4 and 5, the transmission system of this embodiment is similar to that of the first embodiment except that the first power output component 50 includes a third transmission gear 52 and a fifth transmission gear 54, and the second power output component 60 includes a fourth transmission gear 62 and a sixth transmission gear 64. It is to be noted that those skilled in the art can understand that the first power output component 50 or the second power output component 60 may also include three or more transmission gears.

The third transmission gear 52 meshes with the fifth transmission gear 54, the fourth transmission gear 62 meshes with the sixth transmission gear 64, and the fifth transmission gear 54 meshes with the sixth transmission gear 64. The first transmission gear 30 detachably meshes with the third transmission gear 52, and the second transmission gear 40 detachably meshes with the fourth transmission gear 62. When the first transmission gear 30 meshes with the third transmission gear 52 and the second transmission gear 40 is driven away from the fourth transmission gear 62 due to the counterclockwise rotation of the main gear 20, the main gear 20 drives the third transmission gear 52, the fifth transmission gear 54, the sixth transmission gear 64 and the fourth transmission gear 62, as shown in FIG. 4.

On the other hand, when the second transmission gear 40 meshes with the fourth transmission gear 62 and the first transmission gear 30 is driven away from the third transmission gear 52 due to the clockwise rotation of the main gear 20, the main gear 20 drives the fourth transmission gear 62, the sixth transmission gear 64, the fifth transmission gear 54 and the third transmission gear 52, as shown in FIG. 5. Therefore, the third transmission gear 52, the fifth transmission gear 54, the fourth transmission gear 62 and the sixth transmission gear 64 are perpetually rotated in one direction despite the rotational direction of the main gear 20. In this embodiment, the fifth transmission gear 54 and the fourth transmission gear 62 are driven to rotate clockwise, and the sixth transmission gear 64 and the third transmission gear 52 are driven to rotate counterclockwise.

When the transmission system of this embodiment is applied to the sheet feeding apparatus 100, the unidirectional rotation roller 120 may be driven by one of the fifth transmission gear 54 and the sixth transmission gear 64 to rotate in the first direction, and may also be driven by one of the third transmission gear 52 and the fourth transmission gear 62 to rotate in the second direction.

In summary, the invention provides a bidirectional-to-unidirectional transmission system and a sheet feeding apparatus using the same, wherein the transmission system outputs a unidirectional motive power (clockwise or counterclockwise) without respect to directions of inputted motive power through the mechanism design. Thus, the problem encountered when performing duplex image processing can be solved. Moreover, the costs of the transmission system and the sheet feeding apparatus can be decreased.

While the invention has been described by way of examples and in terms of preferred embodiments, it is to be understood that the invention is not limited thereto. To the contrary, it is intended to cover various modifications. Therefore, the scope of the appended claims should be accorded the broadest interpretation so as to encompass all such modifications.

What is claimed is:

1. A transmission system, comprising:
a main gear rotatably disposed;
a first transmission gear and a second transmission gear, rotatably and movably disposed and being respectively in constant mesh with the main gear; and
a first power output component and a second power output component, rotatably disposed and being in constant mesh with each other, the first transmission gear detachably meshing with the first power output component, and the second transmission gear detachably meshing with the second power output component, wherein:
the main gear is rotated counterclockwise to drive the second transmission gear away from the second power output component, and to drive the first transmission gear to mesh with the first power output component to rotate the first power output component and the second power output component; and
the main gear is rotated clockwise to drive the first transmission gear away from the first power output component, and to drive the second transmission gear to mesh with the second power output component to rotate the second power output component and the first power output component.

2. The transmission system according to claim 1, wherein the first power output component comprises a third transmission gear, and the second power output component comprises a fourth transmission gear.

3. The transmission system according to claim 2, wherein the third transmission gear is rotated counterclockwise, and the fourth transmission gear is rotated clockwise.

4. The transmission system according to claim 1, wherein the first power output component comprises a third transmission gear and a fifth transmission gear, and the second power output component comprises a fourth transmission gear and a sixth transmission gear, wherein the third transmission gear meshes with the fifth transmission gear, the fourth transmission gear meshes with the sixth transmission gear, the fifth transmission gear meshes with the sixth transmission gear, the first transmission gear detachably meshes with the third transmission gear, and the second transmission gear detachably meshes with the fourth transmission gear.

5. The transmission system according to claim 4, wherein the fifth transmission gear is rotated clockwise, and the sixth transmission gear is rotated counterclockwise.

6. The transmission system according to claim 1, wherein the first transmission gear is rotatably and movably mounted on a first pin and is provided with a first gear bore for receiving the first pin, and the second transmission gear is rotatably and movably mounted on a second pin and is provided with a second gear bore for receiving the second pin, wherein the first gear bore and the second gear bore allow the first transmission gear and the second transmission gear to move in extending directions of the first gear bore and the second gear bore.

7. A sheet feeding apparatus, comprising:
a first passageway, a second passageway and a third passageway connected to the first passageway and the second passageway;
a unidirectional rotation roller, for rotating in a first direction to transport a sheet into the first passageway and the second passageway;
a bidirectional rotation roller, for rotating in the first direction to transport the sheet out of the second passageway, and for rotating in a second direction reverse to the first direction to transport the sheet from the second passageway to the third passageway and the first passageway; and
a transmission system for driving the unidirectional rotation roller and the bidirectional rotation roller, the transmission system comprising:
a main gear rotatably disposed, the bidirectional rotation roller being driven by the main gear to rotate in one of the first direction and the second direction;
a first transmission gear and a second transmission gear, rotatably and movably disposed and being respectively in constant mesh with the main gear; and
a first power output component and a second power output component, rotatably disposed and being in constant mesh with each other, the first transmission gear detachably meshing with the first power output component, the second transmission gear detachably meshing with the second power output component, and the unidirectional rotation roller being driven by one of the first power output component and the second power output component to rotate in the first direction, wherein:
the main gear is rotated counterclockwise to drive the second transmission gear away from the second power output component, and to drive the first transmission gear to mesh with the first power output component to rotate the first power output component and the second power output component; and
the main gear is rotated clockwise to drive the first transmission gear away from the first power output component, and to drive the second transmission gear to mesh with the second power output component to rotate the second power output component and the first power output component.

8. The sheet feeding apparatus according to claim 7, wherein the first power output component comprises a third transmission gear, and the second power output component comprises a fourth transmission gear.

9. The sheet feeding apparatus according to claim 8, wherein the third transmission gear is rotated counterclockwise, and the fourth transmission gear is rotated clockwise.

10. The sheet feeding apparatus according to claim 8, wherein the unidirectional rotation roller is driven by one of the third transmission gear and the fourth transmission gear to rotate in the first direction.

11. The sheet feeding apparatus according to claim 7, wherein the first power output component comprises a third transmission gear and a fifth transmission gear, and the second power output component comprises a fourth transmission gear and a sixth transmission gear, wherein the third transmission gear meshes with the fifth transmission gear, the fourth transmission gear meshes with the sixth transmission gear, the fifth transmission gear meshes with the sixth transmission gear, the first transmission gear detachably meshes with the third transmission gear, and the second transmission gear detachably meshes with the fourth transmission gear.

12. The sheet feeding apparatus according to claim 11, wherein the fifth transmission gear is rotated clockwise, and the sixth transmission gear is rotated counterclockwise.

13. The sheet feeding apparatus according to claim 11, wherein the unidirectional rotation roller is driven by one of the fifth transmission gear and the sixth transmission gear to rotate in the first direction

14. The sheet feeding apparatus according to claim 7, wherein the first transmission gear is rotatably and movably mounted on a first pin and is provided with a first gear bore for receiving the first pin, and the second transmission gear is rotatably and movably mounted on a second pin and is provided with a second gear bore for receiving the second pin, wherein the first gear bore and the second gear bore allow the first transmission gear and the second transmission gear to move in extending directions of the first gear bore and the second gear bore.

15. The sheet feeding apparatus according to claim 7, further comprising a scanning module for acquiring an image of the sheet transported through the first passageway.
